(19) United States
(12) Patent Application Publication
(10) Pub. No.: US 2018/0017799 A1
(43) Pub. Date: Jan. 18, 2018

(54) Heads Up Display For Observing Vehicle Perception Activity

(71) Applicant: Ford Global Technologies, LLC, Dearborn, MI (US)

(72) Inventors: Mohamed Ahmad, Mountain View, CA (US); Harpreetsingh Banvait, Sunnyvale, CA (US); Ashley Elizabeth Micks, Sunnyvale, CA (US); Nikhil Nagraj Rao, Union City, CA (US)

(21) Appl. No.: 15/209,181

(22) Filed: Jul. 13, 2016

(51) Int. Cl. G02B 27/01; G06K 9/62; B60R 1/00; G06K 9/00; H04N 9/31; H04N 5/232

(52) U.S. Cl. CPC G02B 27/0179; H04N 9/3191; H04N 9/3179; H04N 5/23293; B60R 1/00; G06K 9/00798; G06K 9/6267; B60R 2300/308; G02B 2027/0181

(57) ABSTRACT

The present invention extends to methods, systems, and computer program products for a heads up display for observing vehicle perception activity. As a vehicle is operating, an occupant can see objects outside of the vehicle through the windshield. Vehicle sensors also sense the objects outside the vehicle. A vehicle projection system can project a heads up display for the sensed objects onto the windshield. The heads up display can be aligned with a driver's point of view so that graphical elements projected on a windshield overlap with their corresponding objects as seen through the windshield. As such, a driver (e.g., a test engineer) is able to view algorithm output (e.g., perception algorithm output) without having to look away from the road while driving. Accordingly, testing driver assist and autonomous driving features is both safer and more efficient. The heads up display can also be used as a driver assist.

### CROSS-REFERENCE TO RELATED APPLICATIONS

Not applicable.

### BACKGROUND

### 1. Field of the Invention

This invention relates generally to the field of vehicle automation, and, more particularly, to a heads up display for observing vehicle perception activity.

### 2. Related Art

Vehicle automation engineers can perform test drives to verify how automation algorithms, for example, perception algorithms, are functioning. To verify algorithm functionality during a test drive, an engineer would typically like to see live feedback showing algorithm output. Based on algorithm output, the engineer can adjust their driving to investigate and collect data about any issues that are encountered.

Testing environments inside some vehicles include a screen mounted in the front dash or on a center console. Alternately, two engineers can perform testing, where a passenger engineer uses a laptop to view algorithm output while a driver engineer drives. However, neither of these arrangements is ideal.

When using an in-vehicle screen, a driving engineer cannot simultaneously drive and see algorithm output on the screen. The driving engineer can only observe algorithm output when taking their eyes off the road to look at the screen. As such, the driving engineer essentially has to look back and forth between the road and the screen in attempt to both safely operate the vehicle and observe algorithm output. Since the screen cannot be viewed all the time, the driving engineer can miss algorithm behavior that might be helpful in troubleshooting an algorithm and collecting more relevant data.

Testing with two engineers is somewhat safer since a passenger engineer can observe and relay relevant algorithm outputs to the driving engineer. However, the testing experience for the driving engineer remains sub-optimal since the driving engineer is not able to directly observe algorithm output. Further, the two engineer approach is costlier since it requires additional personnel to test an algorithm.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example environment that facilitates presenting a heads up display for observing vehicle perception activity.

FIG. 3 illustrates a flow chart of an example method for presenting a heads up display for observing vehicle perception activity.

FIGS. 4A and 4B illustrate an example of projecting a heads up display for a vehicle occupant on a windshield.

### DETAILED DESCRIPTION

The present invention extends to methods, systems, and computer program products for a heads up display for observing vehicle perception activity. A windshield heads up display allows a vehicle occupant (e.g., a driver or passenger) to look at the road while also observing vehicle perception activity. As a vehicle is driven, the occupant can see objects outside of the vehicle through the windshield. Sensors mounted on the vehicle can also sense the objects outside the vehicle. A vehicle projection system can project a heads up display for the sensed objects onto the windshield.

The heads up display can include bounding boxes and classifications for detected objects. For example, the heads up display can include graphical elements identifying lane boundaries and other objects, such as, pedestrians, cars, signs, and other objects that the driver can see through the windshield.

The heads up display can provide a wide field of view, for example, including a vehicle's entire front windshield.

The heads up display can be aligned with an occupant's point of view so that graphical elements projected on a windshield overlap with their corresponding objects seen through the windshield. While riding in a vehicle, an occupant's point of view can change as they look in different directions, move their head, change locations in the vehicle, etc. A projection system can compensate for changes in an occupant's point of by calibrating a heads up display (e.g., before use and/or even during use) to stay aligned with the occupant's point of view. For example, a bounding box can be projected in a different location to compensate for a shift in the occupant's eyes. In one aspect, an occupant facing camera is used with face and pupil detection software to adjust the alignment of the heads up display during use.

As such, an occupant (e.g., a test engineer driver) is able to view algorithm output (e.g., perception algorithm output) without having to look away from the road. Keeping eyes on the road while viewing algorithm output provides an occupant (e.g., a driver) with a better understanding of algorithm behavior. Accordingly, testing driver assist and autonomous driving features is both safer and more efficient.

Aspects of the invention can be used in a testing environment as well as a production environment. In a test environment, testing engineers can use the heads up display to test algorithm behavior. In a production environment, a driver can use a heads up display as a driver assist, for example, to assist when driving in lower visibility conditions (e.g., fog, snow, rain, twilight, etc.). A vehicle can include a switch to turn a heads up display on and off. A passenger in an autonomous vehicle can turn the on heads up display to gain confidence in the algorithms used by the autonomous vehicle. The passenger can then turn off the heads up display when they are confident the autonomous vehicle is operating safely.

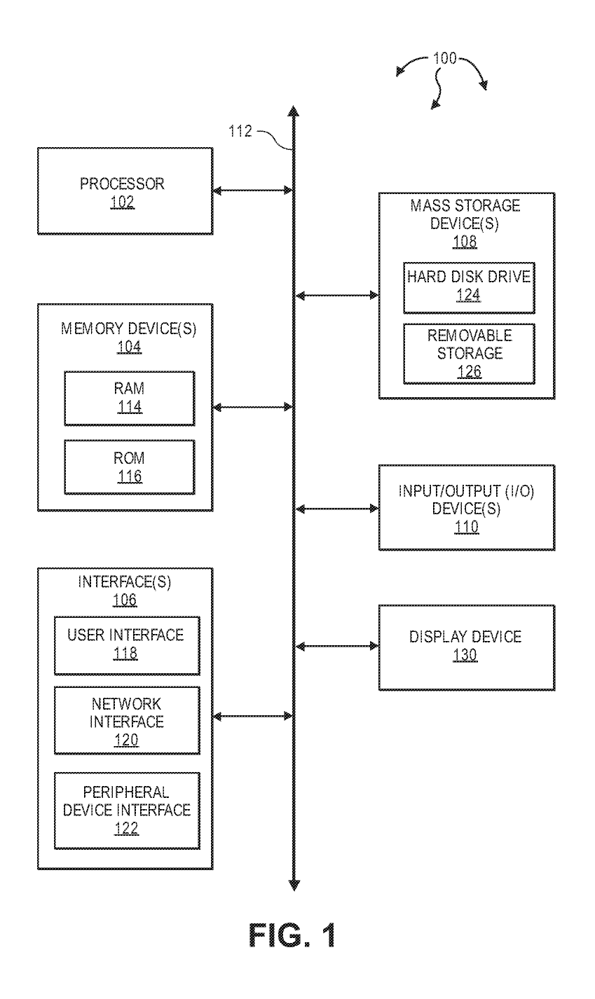

Aspects of the invention can be implemented in a variety of different types of computing devices. FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer storage media, such as magnetic tapes, magnetic disks, optical disks, solid state memory (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, barcode scanners, microphones, monitors or other display devices, speakers, printers, network interface cards, modems, cameras, lenses, radars, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc., networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

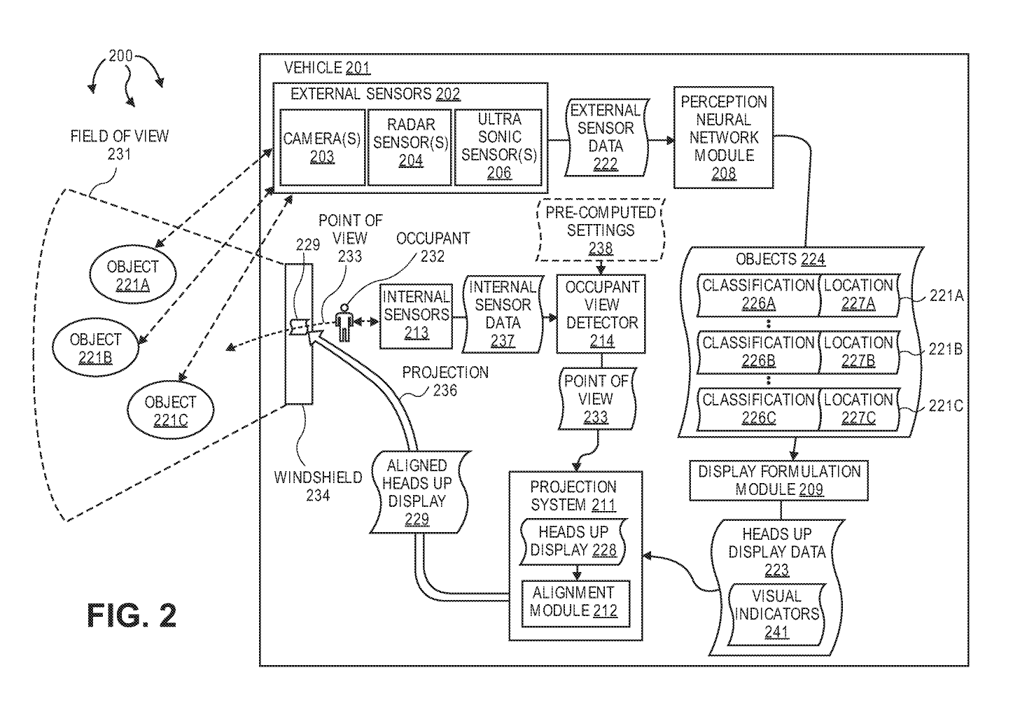

FIG. 2 illustrates an example environment 200 that facilitates a heads up display for observing vehicle perception activity. Environment 200 includes vehicle 201, such as, for example, a car, a truck, or a bus. Vehicle 201 can contain one or more occupants, such as, for example, occupant 232 (which may be a driver or passenger). Environment 200 also includes objects 221A, 221B, and 221C. Each of objects 221A, 221B, and 221C can be one of: roadway markings (e.g., lane boundaries), a pedestrian, a car, a sign, or any other object that occupant 232 can see through windshield 234.

Vehicle 201 includes external sensors 202, perception neural network module 208, display formulation module 209, projection system 211, internal sensors 213, occupant view detector 214, and windshield 234. External sensors 202 are mounted externally on vehicle 201. External sensors 202 include camera(s) 203, radar sensor(s) 204, and ultrasonic sensor(s) 206. External sensors 202 can also include other types of sensors (not shown), such as, for example, acoustic sensors, LIDAR sensors, and electromagnetic sensors. In general, external sensors 202 can monitor objects in a field of view. External sensors 202 can output sensor data indicating the position and optical flow (i.e., direction and speed) of monitored objects. From sensor data, vehicle 201 can project a heads up display on windshield 234 that aligns with a point of view for an occupant of vehicle 201.

Perception neural network module 208 can receive sensor data for objects within a field of view. Perception neural network module 208 can process the sensor data to identify objects of interest within the field of view. Perception neural network module 208 can use one or more perception algorithms to classify objects. Object classifications can include, lane boundaries, cross-walks, signs, control signals, cars, trucks, pedestrians, etc. Some object classifications can have sub-classifications. For example, a sign can be classified by sign type, such as, a stop sign, a yield sign, a school zone sign, a speed limit sign, etc. Perception neural network module 208 can also determine the location of an object within a field of view. If an object is moving, perception neural network module 208 can also determine a likely path of the obj ect.

Perception neural network module 208 can include a neural network architected in accordance with a multi-layer (or “deep”) model. A multi-layer neural network model can include an input layer, a plurality of hidden layers, and an output layer. A multi-layer neural network model may also include a loss layer. For classification of sensor data (e.g., an image), values in the sensor data (e.g., pixel-values) are assigned to input nodes and then fed through the plurality of hidden layers of the neural network. The plurality of hidden layers can perform a number of non-linear transformations. At the end of the transformations, an output node yields a value that corresponds to an object classification and location (and possibly a likely path of travel).

Display formulation module 209 is configured to formulate heads up display data for objects of interest within a field of view. Formulating heads up display data can include formulating visual indicators corresponding to objects of interest within the field of view. For example, display formulation module 209 can formulate highlights for roadway markings and bounding boxes for other objects of interest.

Internal sensors 213 (e.g., a camera) can monitor occupants of vehicle 201. Internal sensors 213 can send sensor data to occupant view detector 214. In one aspect, occupant view detector 214 uses internal sensor data (e.g., eye and/or head tracking data) to determine a point of view for an occupant of vehicle 201. Occupant view detector 214 can update the point of view for the occupant as updated internal sensor data is received. For example, a new point of view for an occupant can be determined when an occupant moves their eyes and/or turns their head in a different direction.

In another aspect, occupant view detector 214 uses pre-configured settings to determine a point of view for an occupant of vehicle 201. The determined point of view can remain constant when vehicle 201 lacks internal sensors (e.g., a camera). For example, a test engineer can pre-configure a point of view that is used throughout a test.

In a further aspect, occupant view detector 214 uses pre-configured settings to determine an initial point of view for an occupant of vehicle 201. Occupant view detector 214 can then update the point of view for the occupant as updated internal sensor data is received.

Projection system 211 is configured to create a heads up display for an occupant of vehicle 201 from heads up display data and based on the occupant's point of view. Projection system 211 can include software and hardware components (e.g., a projector) for projecting the heads up display on windshield 234. Alignment module 212 can align projection of the heads up display for the occupant based on the occupant's point of view into a field of view. Aligning projection of a heads up display can include projecting visual indicators onto windshield 234 to overly the visual indicators on the occupant's perception of the field of view.

Projection system 211 can project a heads up display that spans the entirety of windshield 234. Thus, a heads up display can enhance an occupant's entire field of view through windshield 234 and is aligned with the occupant's point of view into the field of view.

From a heads up display on windshield 234, a test engineer can observe the behavior of perception algorithms in perception neural network 208. Similarly, a driver may be able to better perceive a roadway in lower visibility conditions.

In one aspect, windshield 234 is a front windshield of vehicle 201. In another aspect, windshield 234 is a rear windshield of vehicle 201. In further aspects, windshield 234 is a window of vehicle 201.

Components of vehicle 201 can be connected to one another over (or be part of) a network, such as, for example, a PAN, a LAN, a WAN, a controller area network (CAN) bus, and even the Internet. Accordingly, the components of vehicle 201, as well as any other connected computer systems and their components, can create message related data and exchange message related data (e.g., near field communication (NFC) payloads, Bluetooth packets, Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), etc.) over the network.

Vehicle 201 can include a heterogeneous computing platform having a variety of different types and numbers of processors. For example, the heterogeneous computing platform can include at least one Central Processing Unit (CPU), at least one Graphical Processing Unit (GPU), and at least one Field Programmable Gate Array (FPGA). Aspects of the invention can be implemented across the different types and numbers of processors.

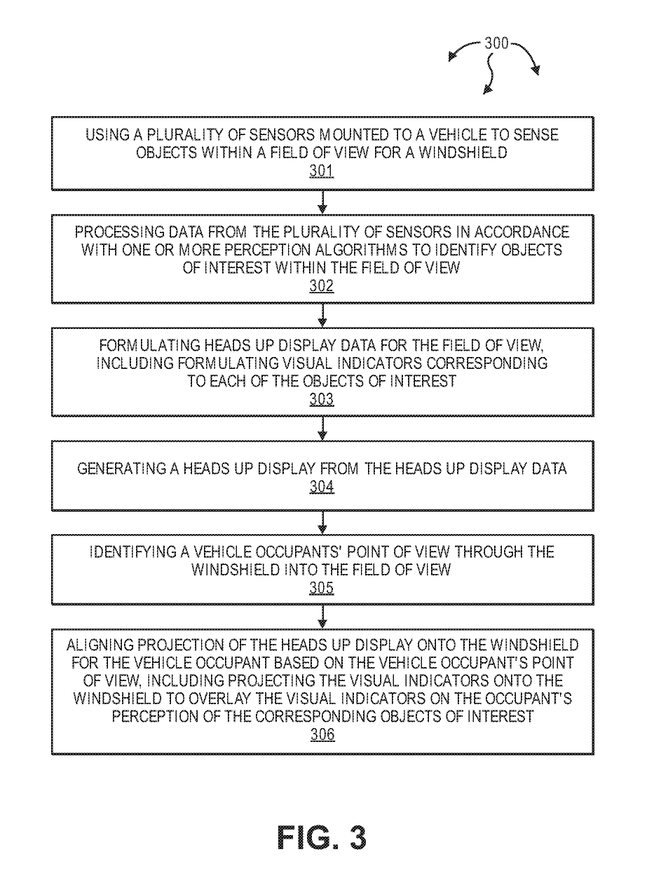

FIG. 3 illustrates a flow chart of an example method 300 for displaying a heads up display on a windshield of the vehicle. Method 300 will be described with respect to the components and data of environment 200.

Method 300 includes using a plurality of sensors mounted to the vehicle to sense objects within a field of view of for a windshield (301). For example, external sensors 202 can be used to sense objects 221A, 221B, and 221C within field of view 231 for windshield 234. In response to sensing objects 221A, 221B, and 221C external sensors 202 can generate external sensor data 222. External sensor data 222 can include object characteristics (size, shape, etc.), location, speed, direction of travel, etc. for objects 221A, 221B, and 221C.

Method 300 includes processing data from the plurality of sensors in accordance with one or more perception algorithms to identify objects of interest within the field of view (302). For example, perception neural network module 208 can processor external sensor data 222 in accordance with one or more perception algorithms to identify objects 224 in field of view 231. Objects 224 includes objects 221A, 221B, and 222C in field of view 231. Perception neural network module 208 can classify each object and determine the location of each of in field of view 231. For example, perception neural network module 208 can assign classification 226A (e.g., a car) and location 227A for object 221A, can assign classification 226B (e.g., a lane boundary) and location 227B for object 221B, and can assign classification 226C (e.g., a pedestrian) and location 227C for object 221C.

Method 300 includes formulating heads up display data for the field of view, including formulating visual indicators corresponding to each of the objects of interest (303). For example, display formulation module 209 can formulate heads up display data 223 for field of view 231. Formulating head up display data 223 can include formulating visual indicators 241 corresponding to each of objects 221A, 221B, and 221C. For example, visual indicators 241 can include bounding boxes for objects 221A (e.g., a car) and 221C (e.g., a pedestrian) and a highlight for object 221B (e.g., a lane boundary).

Method 300 includes generating a heads up display from the heads up display data (304). For example, projection system 211 can generate heads up display 228 from heads up display data 223.

Method 300 includes identifying a vehicle occupant's point of view through the windshield into the field of view (305). For example, occupant view detector 214 can identity that occupant 232 has point of view 233 through windshield 234 into field of view 231. In one aspect, internal sensors 213 generate internal sensor data 237 by monitoring one or more of: the eyes of occupant 232, facial features of occupant 232, the direction of occupant 232′s head, the location of occupant 232 in vehicle 201, and the height of occupant 232′s head relative to windshield 234. Occupant view detector 214 can include eye and/or facial tracking software that uses internal sensor data 237 to identify point of view 233. In another aspect, occupant view detector 214 uses pre-computed settings 238 to identify point of view 233.

Method 300 includes aligning projection of the heads up display onto the windshield for the vehicle occupant based on the vehicle occupant's point of view, including projecting the visual indicators onto the windshield to overlay the visual indicators on the occupant's perception of the corresponding objects of interest (306). For example, alignment module 212 can align heads up display 228 for occupant 232 based on point of view 233. Projection system 211 can project 236 aligned heads up display 229 onto windshield 234. Projecting aligned heads up display 229 can include projecting visual indicators 241 to overlay visual indicators 241 on occupant 232′s perception of objects 221A, 221B, and 221C.

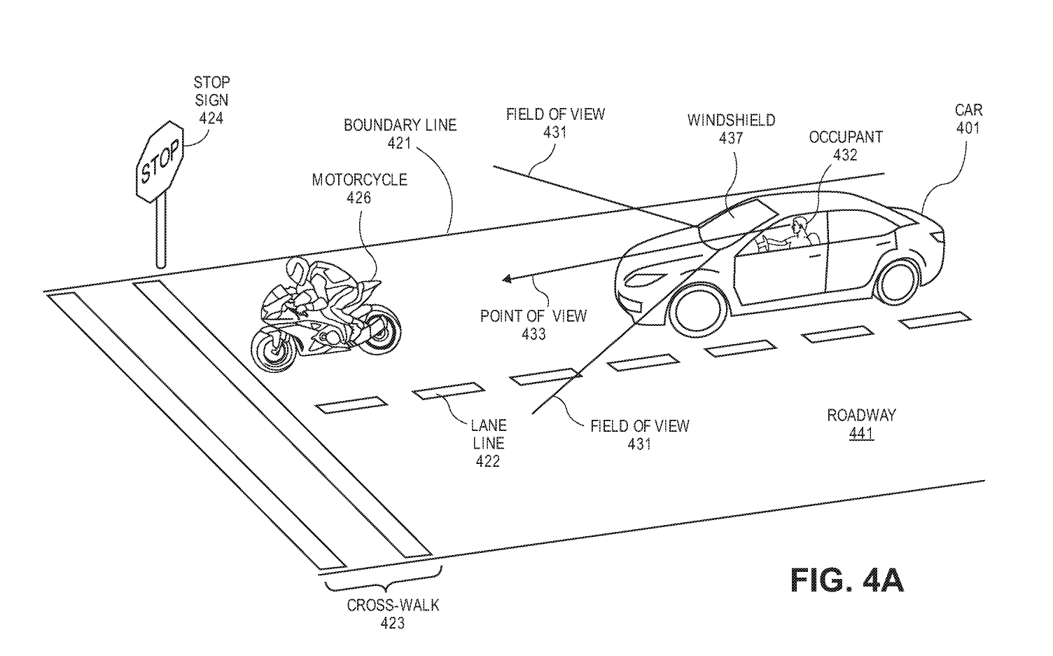

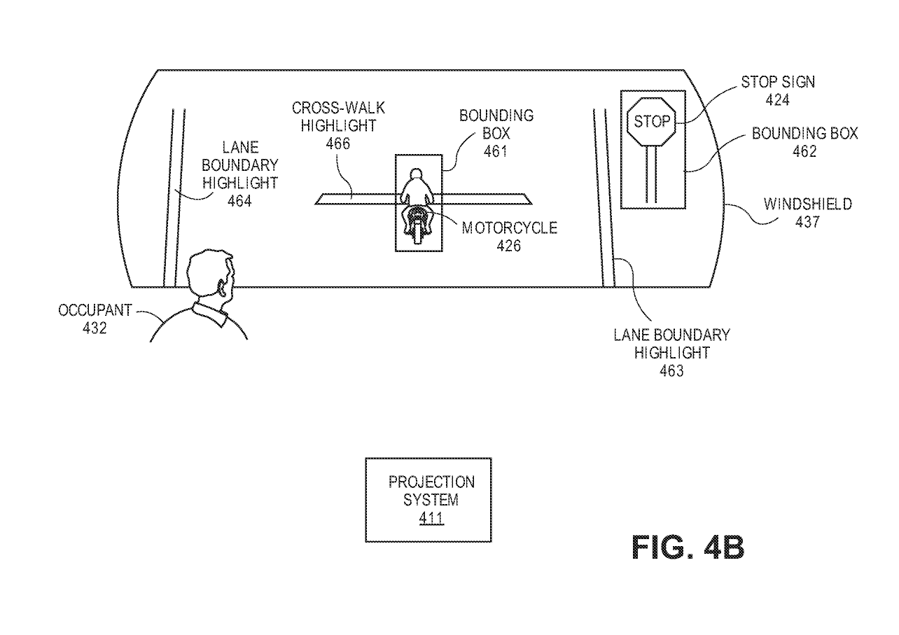

FIGS. 4A and 4B illustrate an example of projecting a heads up display for a vehicle occupant on a windshield. FIG. 4A includes car 401, boundary line 421, lane line 422, cross-walk 423, and stop sign 424. Car 401 and motorcycle 426 can be traveling on roadway 441 approaching stop sign 424. Front windshield 437 provides field of view 431 for occupant 432 (which may be a driver and/or passenger) as car 401 approaches stop sign 424. Occupant 432 is looking at point of view 433 into field of view 431.

Sensors mounted on car 401 can sense boundary line 421, lane line 422, cross-walk 423, and stop sign 424 as car 401 approaches stop sign 424. An occupant facing camera inside car 401 can be used along with face and pupil detection software to identify point of view 433. Other components within car 401 can interoperate to project a heads up display spanning windshield 437. The heads up display can be aligned for occupant 432 based on point of view 433. As such, visual indicators for boundary line 421, lane line 422, cross-walk 423, and stop sign 424 are projected onto windshield 437. The visual indicators overlay with boundary line 421, lane line 422, cross-walk 423, and stop sign 424 as occupant 432 views field of view 431 through windshield 437.

Turning to FIG. 4B, FIG. 4B depicts a heads up display on windshield 437. Projection system can 411 can project a heads ups display including bounding boxes 461 and 462, lane boundary highlights 463 and 464, and cross-walk highlight 466. As depicted, bounding box 461 surrounds occupant 432′s view of motorcycle 426. Similarly, bounding box 462 surrounds occupant 432′s view of stop sign 424. Lane boundary highlights 463 and 464 indicate boundary line 421 and lane line 422 respectively. Cross-walk highlight 466 indicates cross-walk 423.

Occupant 432 can use the heads up display projected onto windshield 437 to evaluate the behavior of perception algorithms running in car 401 and/or for driver assist purposes.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can transform information between different formats, such as, for example, sensor data, identified objects, object classifications, object locations, heads up display data, visual indicators, heads up displays, aligned heads up displays, occupant points of view, pre-computed configuration settings, etc.

System memory can be coupled to the one or more processors and can store instructions (e.g., computer-readable instructions, computer-executable instructions, etc.) executed by the one or more processors. The system memory can also be configured to store any of a plurality of other types of data generated by the described components, such as, for example, sensor data, identified objects, objet classifications, object locations, heads up display data, visual indicators, heads up displays, aligned heads up displays, occupant points of view, pre-computed configuration settings, etc.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash or other vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

What is claimed:

1. A method for use at a vehicle, the method for presenting a display on a windshield, the method comprising:
determining an occupant's point of view through the windshield;
using vehicle sensors to sense an environment outside the vehicle;
forming a display for objects of interest within the occupant's field of view in the environment; and
aligning projection of the display on the windshield with the occupant's point of view.

2. The method of claim 1, wherein determining an occupant's point of view through the windshield comprises manually determining the occupant's point of view through the windshield.

3. The method of claim 1, wherein determining an occupant's point of view through the windshield comprises using sensors in the vehicle's cabin to automatically determining an occupant's field of view through the windshield.

4. The method of claim 1, wherein forming a display for objects of interest within the occupant's field of view comprises forming lane highlights for one or more lane boundaries on a roadway in the environment; and
wherein aligning projection of the display on the windshield comprises aligning display of the lane highlights on the windshield with the one or more lane boundaries on the roadway so that the lane highlights overlap with the lane boundaries when the display is perceived from the occupant's point of view through the windshield.

5. The method of claim 1, wherein forming a display of objects of interest within the occupant's field of view comprises forming bounding rectangles for one or more objects in the environment; and
wherein aligning projection of the display on the windshield comprises aligning display of the bounding rectangles on the windshield with the one or more objects in the environment so that a bounding rectangle bounds each of the one or more objects when the display is perceived from the driver's point of view through the windshield.

6. The method of claim 1, wherein forming a display of objects of interest within the occupant's field of view comprises classifying for one or more objects in the environment; and
wherein aligning projection of the display on the windshield comprises aligning display of the classifications on the windshield with the one or more objects in the environment so that a classification is indicated next to each of the one or more objects when the display is perceived from the occupant's point of view through the windshield.

7. A method for use at a vehicle, the method for displaying a heads up display on a windshield of the vehicle, the method comprising:
using a plurality of sensors mounted to the vehicle to sense objects within a field of view for the windshield;
processing data from the plurality of sensors in accordance with one or more perception algorithms to identify objects of interest within the field of view;
formulating heads up display data for the field of view, including formulating visual indicators corresponding to each of the objects of interest;
generating a heads up display from the heads up display data;
identifying a vehicle occupant's point of view through the windshield into the field of view; and
aligning projection of the heads up display onto the windshield for the vehicle occupant based on the vehicle occupant's point of view, including projecting the visual indicators onto the windshield to overlay the visual indicators on the occupant's perception of the corresponding objects of interest.

8. The method as recited in claim 7, wherein processing data from the plurality of sensors in accordance with one or more perception algorithms to identify objects of interest within the field of view comprises identifying one or more of: another vehicle, a pedestrian, a traffic sign, a traffic signal, and a roadway marking.

9. The method of claim 7, wherein identifying a vehicle occupant's point of view through the windshield comprises identifying a vehicle occupant's point of view from pre-computed settings.

10. The method of claim 7, wherein identifying a vehicle occupant's point of view through the windshield comprises identifying a vehicle occupant's point of view from sensor data, the sensor data received from an occupant facing camera.

11. The method of claim 7, wherein identifying a vehicle occupant's point of view through the windshield comprises identifying a change to the vehicle occupant's point of view from sensor data, the sensor data received from an occupant facing camera.

12. The method of claim 7, wherein identifying a vehicle occupant's point of view through the windshield comprises identifying a vehicle driver's point of view through the windshield.

13. The method of claim 1, wherein projecting the visual indicators onto the windshield comprises projecting a highlight for a roadway marking onto the windshield.

14. The method of claim 1, wherein projecting the visual indicators onto the windshield comprises projecting a bounding box for an object of interest onto the windshield.

15. A vehicle, the vehicle comprising:
a windshield;
one or more externally mounted sensors for sensing objects within a field of view of the windshield;
one or more processors;
system memory coupled to one or more processors, the system memory storing instructions that are executable by the one or more processors;
the one or more processors configured to execute the instructions stored in the system memory to display a heads up display on the windshield, including the following:
process data from the one or more externally mounted sensors in accordance with one or more perception algorithms to identify objects of interest within the field of view;
formulate heads up display data for the field of view, including formulating visual indicators corresponding to each of the objects of interest;
generate a heads up display from the heads up display data;
identify a vehicle occupant's point of view through the windshield into the field of view; and
align projection of the heads up display onto the windshield for the vehicle occupant based on the vehicle occupant's point of view, including projecting the visual indicators onto the windshield to overlay the visual indicators on the occupant's perception of the corresponding objects of interest.

16. The system of claim 15, wherein the one or more externally mounted sensors include on or more of: a camera, a LIDAR sensor, a RADAR sensor, and an ultrasonic sensor

17. The system of claim 15, wherein the one or more processors configured to execute the instructions to identify a vehicle occupant's point of view through the windshield comprises the one or more processors configured to execute the instructions to identify a vehicle occupant's point of view from pre-computed settings.

18. The system of claim 15, wherein the one or more processors configured to execute the instructions to identify a vehicle occupant's point of view through the windshield comprises the one or more processors configured to execute the instructions to identify a vehicle occupant's point of view from sensor data, the sensor data received from an occupant facing camera.

19. The system of claim 15, wherein the one or more processors configured to execute the instructions to project the visual indicators onto the windshield comprise the one or more processors configured to execute the instructions to project a highlight for a roadway marking onto the windshield.

20. The system of claim 15, wherein the one or more processors configured to execute the instructions to project the visual indicators onto the windshield comprise the one or more processors configured to execute the instructions to project a bounding box for an object of interest onto the windshield.
